(19) United States
(12) Patent Application Publication
(10) Pub. No.: US 2016/0328644 A1
(43) Pub. Date: Nov. 10, 2016

(54) ADAPTIVE SELECTION OF ARTIFICIAL NEURAL NETWORKS

(71) Applicant: QUALCOMM Incorporated, San Diego, CA (US)

(72) Inventors: Dexu LIN, San Diego, CA (US); Venkata Sreekanta Reddy ANNAPUREDDY, San Diego, CA (US); Sachin Subhash TALATHI, San Diego, CA (US); Mark STASKAUSKAS, San Diego, CA (US); Aniket VARTAK, San Diego, CA (US); Regan Blythe TOWAL, La Jolla, CA (US); David Jonathan JULIAN, San Diego, CA (US); Anthony SARAH, San Diego, CA (US)

(21) Appl. No.: 14/878,689

(22) Filed: Oct. 8, 2015

Related U.S. Application Data
(60) Provisional application No. 62/159,068, filed on May 8, 2015.

(51) Int. Cl. G06N 3/08; G06N 3/04

(52) U.S. Cl. CPC G06N 3/08; G06N 3/04

(57) ABSTRACT

A method of adaptively selecting a configuration for a machine learning process includes determining current system resources and performance specifications of a current system. A new configuration for the machine learning process is determined based at least in part on the current system resources and the performance specifications. The method also includes dynamically selecting between a current configuration and the new configuration based at least in part on the current system resources and the performance specifications.

### CROSS-REFERENCE TO RELATED APPLICATION

The present application claims the benefit of U.S. Provisional Patent Application No. 62/159,068, filed on May 8, 2015, and titled “Adaptive Selection of Artificial Neural Networks,” the disclosure of which is expressly incorporated by reference herein in its entirety.

### BACKGROUND

1. Field

Certain aspects of the present disclosure generally relate to machine learning and, more particularly, to systems and methods of adaptively selecting configurations for a machine learning process, including an artificial neural network process, based on current system resources and performance specifications.

2. Background

An artificial neural network, which may comprise an interconnected group of artificial neurons (e.g., neuron models), is a computational device or represents a method to be performed by a computational device.

Convolutional neural networks are a type of feed-forward artificial neural network. Convolutional neural networks may include collections of neurons that each have a receptive field and that collectively tile an input space. Convolutional neural networks (CNNs) have numerous applications. In particular, CNNs have broadly been used in the area of pattern recognition and classification.

Deep learning architectures, such as deep belief networks and deep convolutional networks, are layered neural networks architectures in which the output of a first layer of neurons becomes an input to a second layer of neurons, the output of a second layer of neurons becomes and input to a third layer of neurons, and so on. Deep neural networks may be trained to recognize a hierarchy of features and so they have increasingly been used in object recognition applications. Like convolutional neural networks, computation in these deep learning architectures may be distributed over a population of processing nodes, which may be configured in one or more computational chains. These multi-layered architectures may be trained one layer at a time and may be fine-tuned using back propagation.

Other models are also available for object recognition. For example, support vector machines (SVMs) are learning tools that can be applied for classification. Support vector machines include a separating hyperplane (e.g., decision boundary) that categorizes data. The hyperplane is defined by supervised learning. A desired hyperplane increases the margin of the training data. In other words, the hyperplane should have the greatest minimum distance to the training examples.

Although these solutions achieve excellent results on a number of classification benchmarks, their computational complexity can be prohibitively high. Additionally, training of the models may be challenging.

### SUMMARY

In one aspect, a method of adaptively selecting a configuration for a machine learning process is disclosed. The method includes determining current system resources and performance specifications of a current system. The method also includes determining a new configuration for the machine learning process based at least in part on the current system resources and the performance specifications. The method also includes dynamically selecting between a current configuration and the new configuration based at least in part on the current system resources and the performance specifications.

Another aspect discloses an apparatus including means for determining current system resources and performance specifications of a current system. The apparatus also includes means for determining a new configuration for the machine learning process based at least in part on the current system resources and the performance specifications. The apparatus also includes means for dynamically selecting between a current configuration and the new configuration based at least in part on the current system resources and the performance specification

Another aspect discloses wireless communication having a memory and at least one processor coupled to the memory. The processor(s) is configured to determine current system resources and performance specifications of a current system. The processor(s) is also configured to determine a new configuration for the machine learning process based at least in part on the current system resources and the performance specifications. The processor is also configured to dynamically select between a current configuration and the new configuration based at least in part on the current system resources and the performance specifications.

Another aspect discloses a non-transitory computer-readable medium having non-transitory program code recorded thereon which, when executed by the processor(s), causes the processor(s) to perform operations of determining current system resources and performance specifications of a current system and also determining a new configuration for the machine learning process based at least in part on the current system resources and the performance specifications. The program code also causes the processor(s) to dynamically select between a current configuration and the new configuration based at least in part on the current system resources and the performance specifications.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor in accordance with certain aspects of the present disclosure.

FIG. 2 illustrates an example implementation of a system in accordance with aspects of the present disclosure.

FIG. 3A is a diagram illustrating a neural network in accordance with aspects of the present disclosure.

FIG. 3B is a block diagram illustrating an exemplary deep convolutional network (DCN) in accordance with aspects of the present disclosure.

FIG. 4 is a block diagram illustrating an overall example of adaptive selection in a machine learning process in accordance with aspects of the present disclosure.

FIG. 5 illustrates a method of adaptively selecting a configuration for a machine learning process according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### Adaptive Selection of Machine Learning Processes Including Artificial Neural Networks

Aspects of the present disclosure are directed to adaptively selecting an artificial neural network based on current system resources and performance specifications. In particular, configurations for an adaptive model conversion may take place when a model is transferred from one device to another, for example, when an artificial neural network (ANN) designed for a server is downloaded to a mobile device, or when an ANN is downloaded from a computer to a robot. Additionally, adaptive model conversion may take place when the host device on which the ANN operates experiences changes in available resources. For example, the host device may experience changes in processor load, memory bandwidth, battery life, and/or communication speed. Moreover, adaptive model conversion may take place when the environment changes. For example, desired latency specifications for an object recognition task may differ when an automobile is stationary compared to when an automobile is moving.

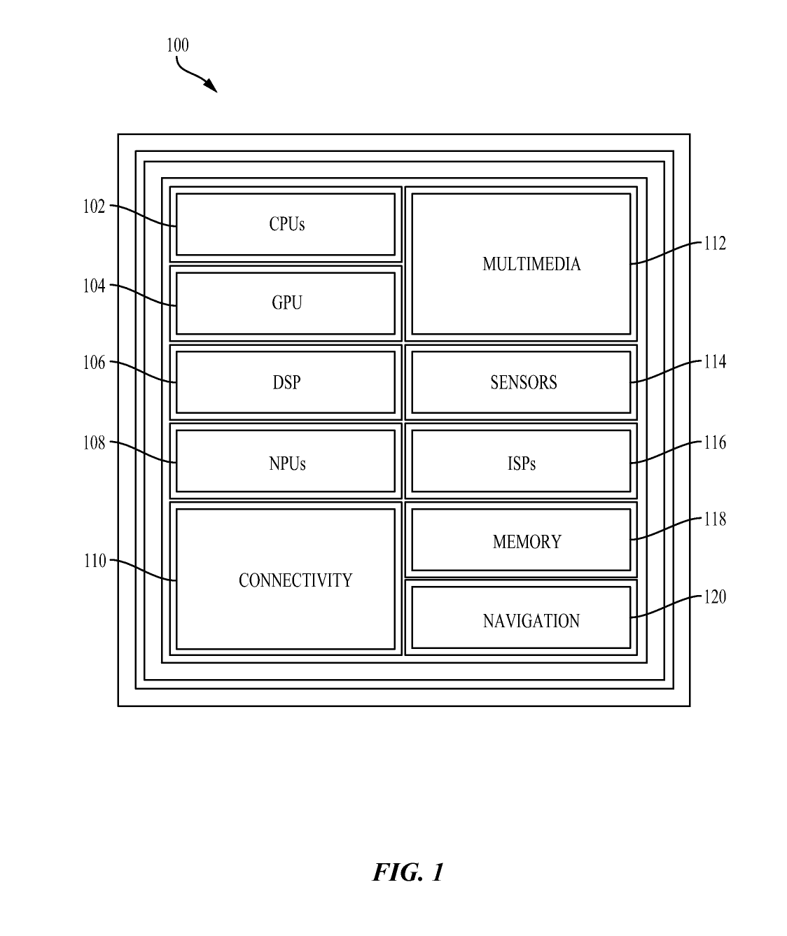

FIG. 1 illustrates an example implementation of the aforementioned adaptive selection method using a system-on-a-chip (SOC) 100, which may include a general-purpose processor (CPU) or multi-core general-purpose processors (CPUs) 102 in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NU) 108, in a memory block associated with a CPU 102, in a memory block associated with a graphics processing unit (GPU) 104, in a memory block associated with a digital signal processor (DSP) 106, in a dedicated memory block 118, or may be distributed across multiple blocks. Instructions executed at the general-purpose processor 102 may be loaded from a program memory associated with the CPU 102 or may be loaded from a dedicated memory block 118.

The SOC. 100 may also include additional processing blocks tailored to specific functions, such as a GPU 104, a DSP 106, a connectivity block 110, which may include fourth generation long term evolution (4G LTE) connectivity, unlicensed Wi-Fi connectivity, USB connectivity, Bluetooth connectivity, and the like, and a multimedia processor 112 that may, for example, detect and recognize gestures. In one implementation, the NU is implemented in the CPU, DSP, and/or GPU. The SOC. 100 may also include a sensor processor 114, image signal processors (ISPs), and/or navigation 120, which may include a global positioning system.

The SOC. 100 may be based on an ARM instruction set. In an aspect of the present disclosure, the instructions loaded into the general-purpose processor 102 may comprise code for determining current system resources and performance specifications of a current system. The instructions loaded into the general-purpose processor 102 may also comprise code for determining a new configuration for the machine learning process based at least in part on the system resources and the performance specifications determined for the current system. The instructions loaded into the general-purpose processor 102 may also comprise code for dynamically selecting between a current configuration and the new configuration based at least in part on system resources and the performance specifications of the current system.

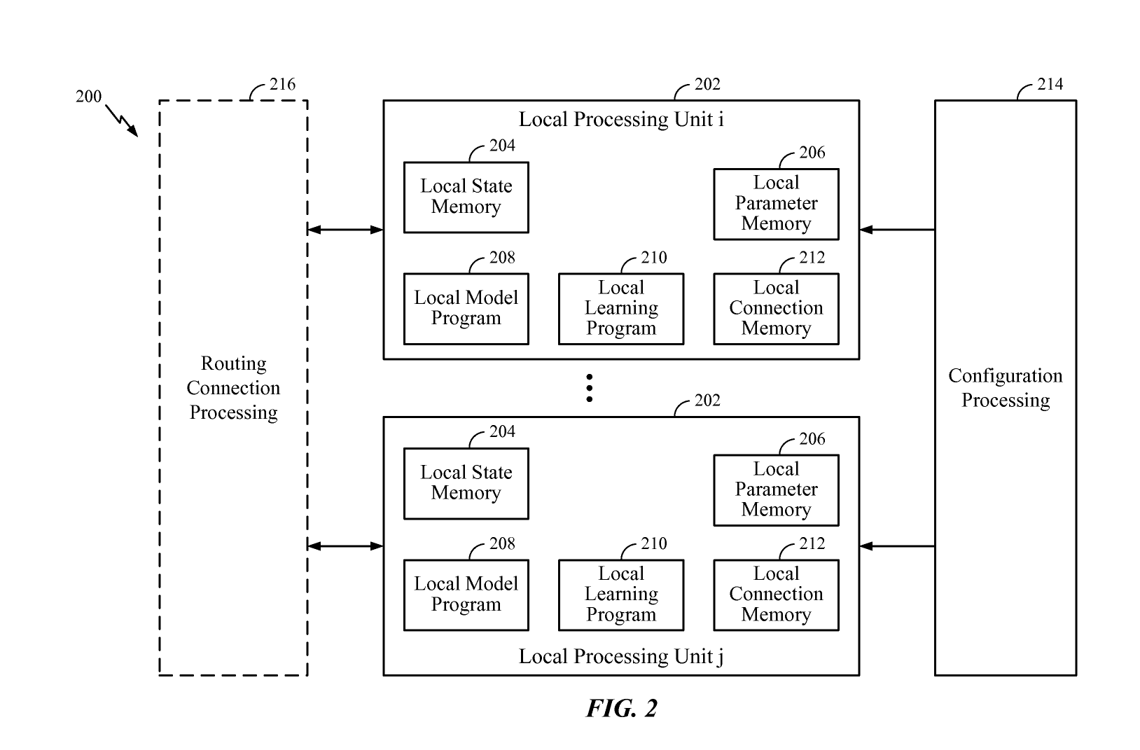

FIG. 2 illustrates an example implementation of a system 200 in accordance with certain aspects of the present disclosure. As illustrated in FIG. 2, the system 200 may have multiple local processing units 202 that may perform various operations of methods described herein. Each local processing unit 202 may comprise a local state memory 204 and a local parameter memory 206 that may store parameters of a neural network. In addition, the local processing unit 202 may have a local (neuron) model program (LMP) memory 208 for storing a local model program, a local learning program (LLP) memory 210 for storing a local learning program, and a local connection memory 212. Furthermore, as illustrated in FIG. 2, each local processing unit 202 may interface with a configuration processor unit 214 for providing configurations for local memories of the local processing unit, and with a routing connection processing unit 216 that provides routing between the local processing units 202.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

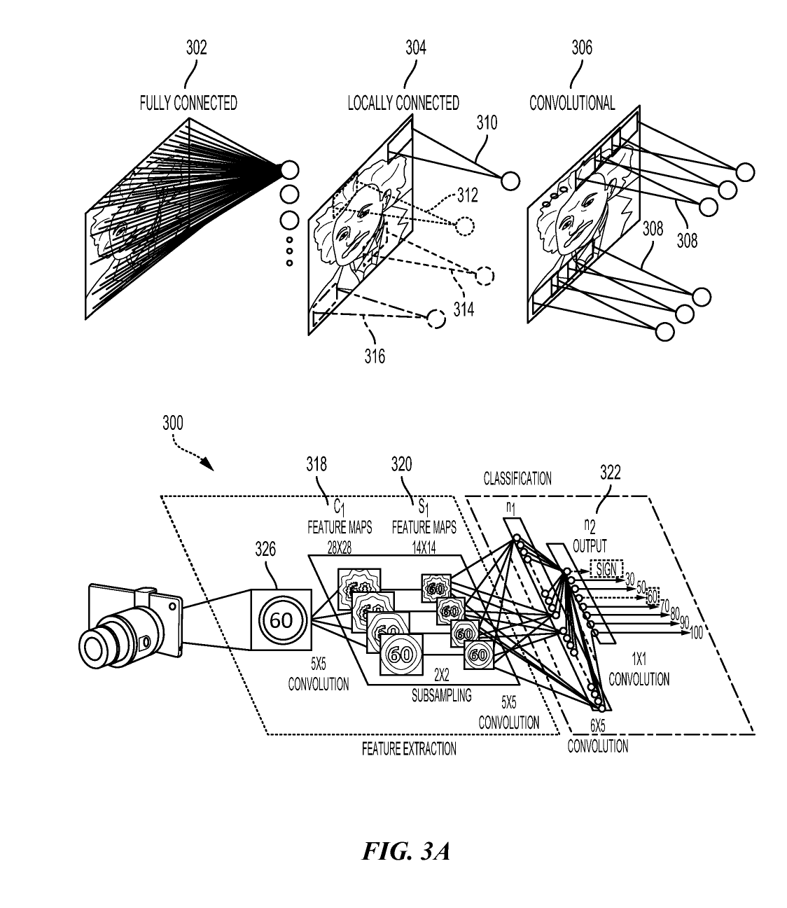

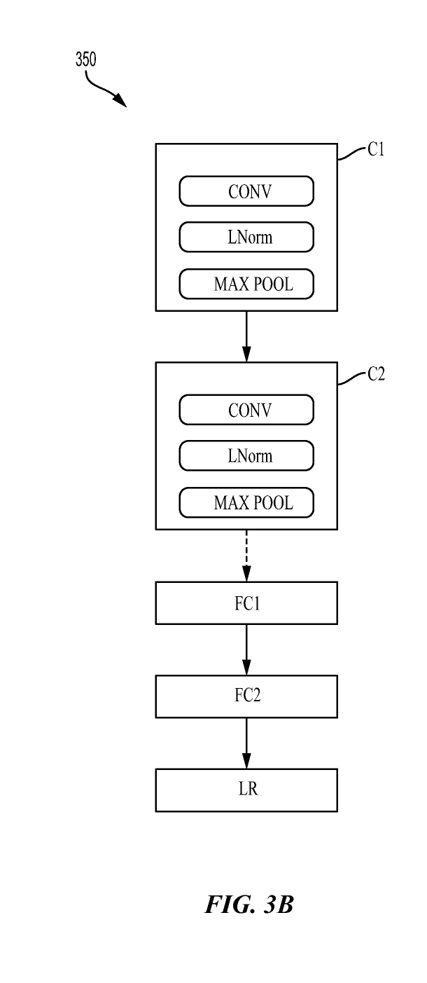

Referring to FIG. 3A, the connections between layers of a neural network may be fully connected 302 or locally connected 304. In a fully connected network 302, a neuron in a first layer may communicate its output to every neuron in a second layer, so that each neuron in the second layer will receive input from every neuron in the first layer. Alternatively, in a locally connected network 304, a neuron in a first layer may be connected to a limited number of neurons in the second layer. A convolutional network 306 may be locally connected, and is further configured such that the connection strengths associated with the inputs for each neuron in the second layer are shared (e.g., 308). More generally, a locally connected layer of a network may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

Locally connected neural networks may be well suited to problems in which the spatial location of inputs is meaningful. For instance, a network 300 designed to recognize visual features from a car-mounted camera may develop high layer neurons with different properties depending on their association with the lower versus the upper portion of the image. Neurons associated with the lower portion of the image may learn to recognize lane markings, for example, while neurons associated with the upper portion of the image may learn to recognize traffic lights, traffic signs, and the like.

A DCN may be trained with supervised learning. During training, a DCN may be presented with an image, such as a cropped image of a speed limit sign 326, and a “forward pass” may then be computed to produce an output 322. The output 322 may be a vector of values corresponding to features such as “sign,” “60,” and “100.” The network designer may want the DCN to output a high score for some of the neurons in the output feature vector, for example the ones corresponding to “sign” and “60” as shown in the output 322 for a network 300 that has been trained. Before training, the output produced by the DCN is likely to be incorrect, and so an error may be calculated between the actual output and the target output. The weights of the DCN may then be adjusted so that the output scores of the DCN are more closely aligned with the target.

To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level.

After learning, the DCN may be presented with new images 326 and a forward pass through the network may yield an output 322 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer 318 and 320, with each element of the feature map (e.g., 320) receiving input from a range of neurons in the previous layer (e.g., 318) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

FIG. 3B is a block diagram illustrating an exemplary deep convolutional network 350. The deep convolutional network 350 may include multiple different types of layers based on connectivity and weight sharing. As shown in FIG. 3B, the exemplary deep convolutional network 350 includes multiple convolution blocks (e.g., C1 and C2). Each of the convolution blocks may be configured with a convolution layer, a normalization layer (LNorm), and a pooling layer. The convolution layers may include one or more convolutional filters, which may be applied to the input data to generate a feature map. Although only two convolution blocks are shown, the present disclosure is not so limiting, and instead, any number of convolutional blocks may be included in the deep convolutional network 350 according to design preference. The normalization layer may be used to normalize the output of the convolution filters. For example, the normalization layer may provide whitening or lateral inhibition. The pooling layer may provide down sampling aggregation over space for local invariance and dimensionality reduction.

The parallel filter banks, for example, of a deep convolutional network may be loaded on a CPU 102 or GPU 104 of an SOC. 100, optionally based on an ARM instruction set, to achieve high performance and low power consumption. In alternative embodiments, the parallel filter banks may be loaded on the DSP 106 or an ISP 116 of an SOC. 100. In addition, the DCN may access other processing blocks that may be present on the SOC., such as processing blocks dedicated to sensors 114 and navigation 120.

The deep convolutional network 350 may also include one or more fully connected layers (e.g., FC1 and FC2). The deep convolutional network 350 may further include a logistic regression (LR) layer. Between each layer of the deep convolutional network 350 are weights (not shown) that are to be updated. The output of each layer may serve as an input of a succeeding layer in the deep convolutional network 350 to learn hierarchical feature representations from input data (e.g., images, audio, video, sensor data and/or other input data) supplied at the first convolution block C1.

### Adaptive Selection of Artifical Neural Networks

Aspects of the present disclosure are directed to adaptively selecting the configuration for a machine learning process. The configuration may include hardware and/or software arrangements that affect system function and performance. One example of a machine learning process is an artificial neural network (ANN). Examples of the present disclosure are illustrated with an artificial neural network, however, those skilled in the art will appreciate other various types of machine learning processes may be utilized.

An artificial neural network (ANN) may be used to perform various artificial intelligence tasks, such as detection, localization, and classification. Different realizations of an ANN may perform the same task with different degrees of accuracy. Generally, larger ANN models that use more computational resources may have increased levels of accuracy on a given task when compared with smaller ANN models that were trained to perform the same task. In most cases, the desired accuracy of an ANN model on a task is weighed against the computational resources available to execute the ANN. Furthermore, the computational resources available to execute an ANN may vary over time.

Adaptive model conversion may take place when a model is transferred from one device to another, for example, when an ANN designed for a server is downloaded to a mobile device, or when an ANN is downloaded from a computer to a robot. Additionally, adaptive model conversion may take place when the host device on which the ANN operates experiences changes in available resources. For example, the host device may experience changes in processor load, memory bandwidth, battery life, and/or communication speed. Moreover, adaptive model conversion may take place when the environment changes. For example, desired latency specifications for an object recognition task may differ when an automobile is stationary compared to when an automobile is moving.

Because different scenarios may benefit from the selection of different realizations of an ANN, it is desirable to use a conversion tool to dynamically convert one realization (e.g., model or configurations) to another. In one example, when an ANN designed for a server is downloaded to a mobile device the ANN may be converted to have a smaller model size and/or use fewer multiply and accumulate operations (MACs). In another example, when the battery level on a device is below a threshold, the ANN may be converted to improve power efficiency while the performance remains above a threshold. In yet another example, when one or more applications on the shared processor consume an increased amount of processing power and/or memory bandwidth, the ANN may be converted to use less processing while not increasing an overall delay.

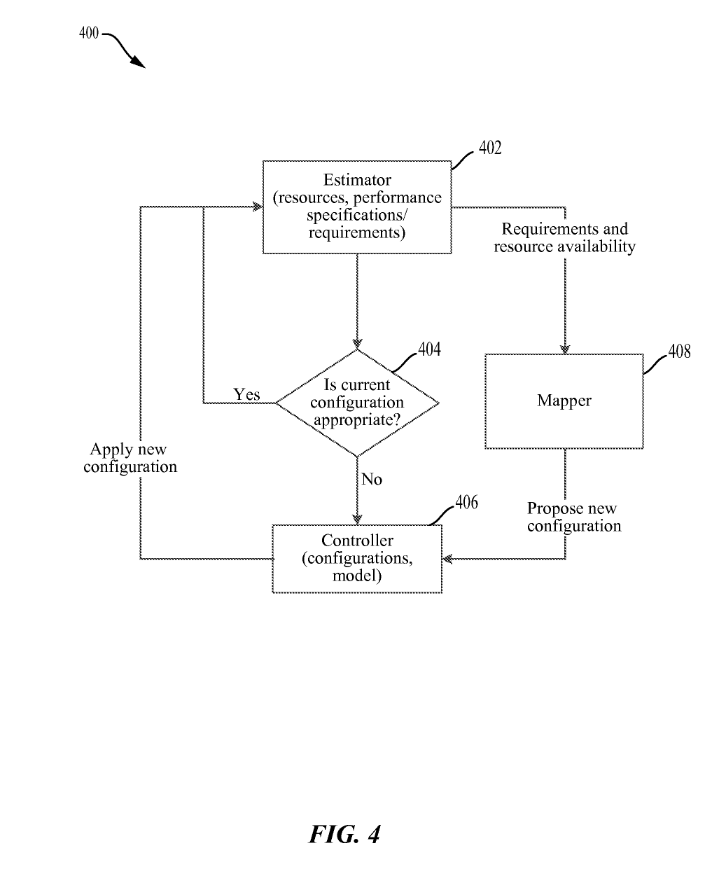

Aspects of the present disclosure are directed to adaptively selecting configurations for a machine learning process based on factors such as system resources and performance specifications. FIG. 4 illustrates an example diagram of an overall process 400 for adaptively selecting configurations. The process 400 may perform an online evaluation to determine factors such as the resource availability and performance requirements. In particular, at block 402, based on an initial baseline model, the performance requirements/specifications and system resources are estimated. Examples of performance requirements and system resources includes, but are not limited to, latency, accuracy requirements, power availability, memory bandwidth, processor occupancy, and communication speed on a device. At block 404, it is determined whether the current configurations are appropriate. If yes, then the current configurations are kept and any changes in requirements or resource constraints are continuously monitored. If the current configurations are not appropriate, at block 406, a controller selects and applies new configurations that satisfy the requirements for system resources and performance specifications.

A mapper may be utilized to collect information regarding resource availability and performance specifications. Based on the collected information, at block 408, a mapper proposes new configurations. The configurations may contain information relevant to describe a model, such as, but not limited to, performance, latency, ease of conversion and implementation, power consumption, processor requirements, memory bandwidth requirements, and/or communication speed requirements.

In one aspect, the proposed configurations are intended to be an improvement over the previous configurations based on the system resources and performance specifications. At block 406, the controller may dynamically select the proposed new configurations.

In another aspect, determining which configuration to select may be based on may factors. In one example, the determination is based on: performance of the current configuration and the new configuration, latencies associated with the current configuration and the new configuration, power consumption associated with the current configuration and the new configuration, ease of applying another configuration, processor resources associated with the current configuration and the new configuration, memory bandwidth associated with the current configuration and the new configuration, and/or communication specifications associated with the current configuration and the new configuration.

The selection of the new configurations is a multi-dimensional optimization problem. Simplification may be applied to speed up the selection process. For example, a cascaded reduction strategy may be applied, where all configurations or models are ranked in a database in the linear order of preference (e.g., from most preferred model to least preferred). Each set of configurations may be evaluated, one by one, until all process requirements (e.g., system resources and performance specifications) are met.

Optionally, in another aspect, a co-processor (e.g., a second processor) may be utilized for configuration selection. In particular, a co-processor accompanies a main processor (e.g., a first processor). The two processors perform the same inference task, while applying potentially different configurations. The outputs of the two processors may be intelligently combined to improve performance. For example, the weighted average of outputs from both processors can be used as the combined output.

In another aspect, the machine learning process continuously executes a first configuration of the machine learning process with a first processor. A second configuration of the machine learning process periodically executed with a second processor. The second configuration has a complexity that is greater than the complexity of the first configuration. Further, the results from the first configuration and the second configuration are aggregated.

In another example, a dedicated processor runs a low-complexity model that is sufficient to deliver the minimum quality of service (QoS), while the other processor (the shared processor) operates on a best effort basis. The model used on the best effort processor is adaptive based on the resources available on that processor.

In one example, the machine learning process is an artificial neural network and the new configurations may be determined by the following: changing a number representation of weights and/or activations in the current configuration, adjusting hyper-parameters based on a current artificial neural network, adopting a student network derived from the current artificial neural network, decomposing filters of the current artificial neural network, compressing the current artificial neural network, reducing image resolution of the current artificial neural network, adjusting sparsity of the current artificial neural network, changing filters of the current artificial neural network, selecting a number of samples for online learning, changing a number of candidate windows considered for localization, and/or performing saliency masking.

Aspects of the present disclosure assist an artificial neural network in operating efficiently and robustly when the availability of system resources fluctuates. Additionally, time-sensitive tasks may be completed within the delay budget even when the processor becomes busy due to other active applications. Further, the battery life may be extended when the battery runs low. The dynamic selection enables performance optimization without user intervention and enables graceful performance degradation without service interruption.

The process of changing a number representation of weights and/or activations in a configuration may be implemented via floating point or fixed point. When the number representation of the weights and activations in an artificial neural network are changed, the network complexity and power consumption may be reduced. This concept is described in each of U.S. Provisional Patent Application No. 62/159,097, filed on May 8, 2015, and titled “BIT WIDTH SELECTION FOR FIXED POINT NEURAL NETWORKS,” and U.S. Provisional Patent Application No. 62/159,079, filed on May 8, 2015, and titled “FIXED POINT NEURAL NETWORK BASED ON FLOATING POINT NEURAL NETWORK QUANTIZATION,” the disclosures of which are expressly incorporated by reference herein in their entireties.

A new configuration may be determined by adjusting hyper-parameters based on a current artificial neural network. Designing deep convolution networks (DCN) for object classification tasks may involve: choosing a suitable DCN architecture; choosing the learning algorithm parameters; initializing the weights of the network; training the network on the training data set in question; and evaluating the performance of the trained network using a validation data set.

The space of DCN architecture parameters and the learning algorithm parameters are referred to as the hyper-parameters. Hyper-parameter optimization may be utilized to identify the optimal values for these hyper-parameters with the goal of maximizing the accuracy of the DCNs on a given classification/regression task.

A database of DCN architectures with varying complexity may be generated offline. For each of these DCN architectures, a hyper-parameter optimization approach may identify a suitable set of learning algorithm hyper-parameters, for obtaining the “optimal” local minima. These optimally trained DCNs are then stored in the database. Depending on the application, and the desired trade-off between complexity and performance, a mapper can propose a suitably trained DCN model from the database. This concept is described in U.S. Provisional Patent Application No. 62/109,470, filed on Jan. 29, 2015, and titled “HYPER-PARAMETER SELECTION FOR DEEP CONVOLUTIONAL NETWORKS,” the disclosure of which is expressly incorporated by reference herein in its entirety.

A new configuration may be determined by adopting a student network derived from the current artificial neural network. A network with a larger capacity (e.g., a teacher network) usually corresponds to greater accuracy. The knowledge acquired by the teacher may be leveraged for training a “student” network. A student network is usually smaller in capacity and usually the preferred choice for mobile applications due to its size. Targets acquired from the trained teacher network may be used to enhance the performance of the student network. The probabilities for the training data from the teacher network are stored and used in training the student network. The probabilities may be modified by a temperature factor, thus making the learning sensitive to relative differences between class probabilities. A database of student networks with different complexity-performance tradeoffs may be generated offline. Depending on the application, and the desired trade-off between complexity and performance, a mapper may propose a suitable trained student network from the database.

A new configuration may be determined by decomposing filters of the current artificial neural network. In particular, a lower complexity network can also be obtained by decomposing 2D convolutions into 1D convolutions. For example, 2D convolution operations can be approximated with a linear combination of concatenated 1D convolution operation(s) using row and column filters. The row and column weight vectors are determined using singular value decomposition (SVD) based low-rank approximation method. Approximation is improved when the original filter matrices begin with a low rank. A nuclear norm may be implemented as a regularizer to encourage low-rank filters during training. Alternately, a low-rank or decomposed structure may be enforced during training.

Furthermore, the compressed network may be fine-tuned to adjust the weight values of the compressed and uncompressed layers. Fine-tuning recaptures the loss in classification accuracy due to compression. The compression parameters can be chosen to satisfy the requirements of system resources and performance specifications. This concept is described in each of U.S. Provisional Patent Application No. 62/025,406, filed on Jul. 16, 2014 and titled “DECOMPOSING CONVOLUTION OPERATION IN NEURAL NETWORKS,” U.S. Non-Provisional patent application Ser. No. 14/526,018, filed on Oct. 28, 2014 and titled “DECOMPOSING CONVOLUTION OPERATION IN NEURAL NETWORKS,” and U.S. Non-Provisional patent application Ser. No. 14/526,046, filed on Oct. 28, 2014 and titled “DECOMPOSING CONVOLUTION OPERATION IN NEURAL NETWORKS,” the disclosures of which are expressly incorporated by reference herein their entirety.

A new configuration may be determined by compressing the current artificial neural network. In particular, in one example, a lower complexity network is obtained by replacing each layer in the original network with multiple compressed layers. A fully-connected layer is replaced with multiple fully-connected layers and a convolution layer is replaced with multiple convolution layers. Additionally, non-linearity may be added between the compressed layers.

The weight matrices of the compressed layers may be obtained through low-rank approximation methods or by an alternating minimization algorithm. Additionally, the compressed network may be fine-tuned to adjust the weight values of the compressed and uncompressed layers. Fine-tuning recaptures the loss in classification accuracy due to compression. The compression parameters can be chosen to satisfy the requirements of system resources and performance specifications. This concept is described in U.S. Provisional Patent Application No. 62/106,608, filed on Jan. 22, 2015 and titled “MODEL COMPRESSION AND FINE-TUNING,” the disclosure of which is expressly incorporated by reference herein in its entirety.

The new configuration may be determined by reducing image resolution of the current artificial neural network. In particular, the image resolution may be reduced at various stages of the DCN. The size of the input image to a DCN may be reduced by a ratio called the reduction factor. Different layers may have different reduction factors. The weights of the convolution layers are adjusted to match the reduced resolution input images. The synaptic connections in the pooling layers are also adjusted to match the reduced resolution input images. Additionally, spectrum analysis may be used to determine the reduction factors for different layers. For example, when there is less energy in high frequency components the resolution can be reduced.

The compressed network can be fine-tuned to adjust the weight values of the compressed and uncompressed layers, such that the fine-tuning recaptures the loss in classification accuracy due to compression. The compression parameters can be chosen to satisfy the requirements from the (RRE) module. The compression parameters can be chosen to satisfy the requirements of system resources and performance specifications. This concept is described in U.S. Provisional Patent Application No. 62/154,084, filed on Apr. 28, 2015 and titled “REDUCING IMAGE RESOLUTION IN DEEP CONVOLUTIONAL NETWORKS,” the disclosure of which is expressly incorporated by reference herein in its entirety.

The new configuration may be determined by adjusting sparsity of the current artificial neural network. The artificial neural networks contain large numbers of redundant parameters (weights) and activations (outputs) that can be set to zero, thereby increasing artificial neural network (ANN) sparsity without impacting ANN performance. Adjusting the model sparsity to a higher level provides a number of benefits to ANN implementations, such as: enabling model compression; reducing memory bandwidth (e.g., zero values do not need to be loaded and processed); and reducing computational requirements (e.g., can skip over processing that involves zero-valued parameters, inputs and outputs).

The sparsity in a model may be increased as follows. First, the desired type of sparsity is identified (e.g., sparse weight matrices, convolutional filters or activations) based on performance objectives (e.g., reduce memory bandwidth, numbers of multiply-accumulate (MAC) operations, etc.). Next, a penalty term is added to the artificial neural network cost function that rewards the desired type(s) of sparsity. Training of the artificial neural network is performed to jointly minimize the original cost function (e.g., classification accuracy) and the sparsity-based penalty term.

This concept is described in U.S. Provisional Patent Application No. 61/930,858, filed on Jan. 23, 2014, and titled “OPERATING A NEURAL NETWORK AT LOW FIRING RATES,” U.S. Provisional Patent Application No. 61/930,849, filed on Jan. 23, 2014, and titled “OPERATING A NEURAL NETWORK USING A REDUCED NUMBER OF MODEL NEURONS,” U.S. Provisional Patent Application No. 61/939,537, filed on Feb. 13, 2014, and titled “OPERATING A NEURAL NETWORK USING A REDUCED NUMBER OF MODEL NEURONS,” U.S. patent application Ser. No. 14/449,092, filed on Jul. 31, 2014 and titled “CONFIGURING NEURAL NETWORK FOR LOW SPIKING RATE,” and U.S. patent application Ser. No. 14/449,101, filed on Jul. 31, 2014, and titled “CONFIGURING SPARSE NEURONAL NETWORKS,” the disclosures of which are expressly incorporated by reference herein in their entireties.

The new configuration may be determined by changing filters of the current artificial neural network. In particular, the filters may be changed based on filter specificity. The filters learned by the base model tend to vary in their specificity for image features. Filter specificity measurements can be taken and used to prioritize which filters to compute and used to intelligently select N filters, where N is determined by current power and speed constraints. This concept is described in U.S. Provisional Patent Application No. 62/154,089, filed on Apr. 28, 2015, and titled “FILTER SPECIFICITY AS TRAINING CRITERION FOR NEURAL NETWORKS,” the disclosure of which is expressly incorporated by reference herein in its entirety.

The new configuration may be determined by selecting a number of samples for online learning. In particular, when retraining top-level classifiers, the speed and computation is directly proportional to the number of samples used for training The N highest priority samples to retrain may be chosen such that N is selected to meet a particular speed or computation limit. This concept is described in U.S. Provisional Patent Application No. 62/134,493, filed on Mar. 17, 2015, and titled “FEATURE SELECTION FOR RETRAINING CLASSIFIERS,” and U.S. Provisional Patent Application No. 62/164,484, filed on May 20, 2015 and titled “FEATURE SELECTION FOR RETRAINING CLASSIFIERS,” the disclosures of which are expressly incorporated by reference herein in their entireties.

The new configuration may be determined by changing a number of candidate windows considered for localization. Modern localization algorithms propose N candidate regions that may contain objects, each of which is evaluated to determine whether an object is indeed present. The N highest priority windows may be chosen based on a confidence measure, where N is chosen to meet a particular speed or accuracy limit. This concept is described in U.S. Provisional Patent Application No. 62/190,685, filed on Jul. 9, 2015 and titled “REAL-TIME OBJECT DETECTION IN IMAGES VIA ONE GLOBAL-LOCAL NETWORK,” the disclosure of which is expressly incorporated by reference herein in its entirety.

The new configuration may be determined by performing saliency masking to reduce the number of pixels processed. For example, by zeroing out pixels in the original image, costly filter multiplications in convolutional based networks can be avoided while still maintaining the ability to do all filter multiplications for high quality applications. This concept is described in U.S. Provisional Patent Application No. 62/131,792, filed on Mar. 11, 2015 and titled “SALIENCY MASKING,” the disclosure of which is expressly incorporated by reference herein in its entirety.

In one configuration, a neuron model is configured to adaptively select a configuration for an artificial neural network. The neuron model includes a determining means, and/or dynamically selecting means. In one aspect, the determining means, and/or dynamically selecting means may be the general-purpose processor 102, program memory associated with the general-purpose processor 102, memory block 118, local processing units 202, and or the routing connection processing units 216 configured to perform the functions recited. In another configuration, the aforementioned means may be any module or any apparatus configured to perform the functions recited by the aforementioned means.

The neuron model may also include a means for continuously executing a first configuration, means for periodically executing a second configuration and/or means for aggregating results from the first configuration and the second configuration. In one aspect, the continuously executing means, periodically executing means and/or aggregating means may be the general-purpose processor 102, program memory associated with the general-purpose processor 102, memory block 118, local processing units 202, and or the routing connection processing units 216 configured to perform the functions recited. In another configuration, the aforementioned means may be any module or any apparatus configured to perform the functions recited by the aforementioned means.

The neuron model may also include means for means for determining the new configuration by changing a number representation of weights and/or activations in the current configuration; means for adjusting hyper-parameters based at least in part on the current artificial neural network; means for adopting a student network derived from the current artificial neural network; means for decomposing filters of the current artificial neural network; means for compressing the current artificial neural network; means for reducing image resolution of the current artificial neural network; means for adjusting sparsity of the current artificial neural network; means for changing filters of the current artificial neural network; means for selecting a number of samples for online learning; means for changing a number of candidate windows considered for localization; and/or means for performing saliency masking. In one aspect, the aforementioned means may be the general-purpose processor 102, program memory associated with the general-purpose processor 102, memory block 118, local processing units 202, and or the routing connection processing units 216 configured to perform the functions recited. In another configuration, the aforementioned means may be any module or any apparatus configured to perform the functions recited by the aforementioned means.

According to certain aspects of the present disclosure, each local processing unit 202 may be configured to determine parameters of the neural network based upon desired one or more functional features of the neural network, and develop the one or more functional features towards the desired functional features as the determined parameters are further adapted, tuned and updated.

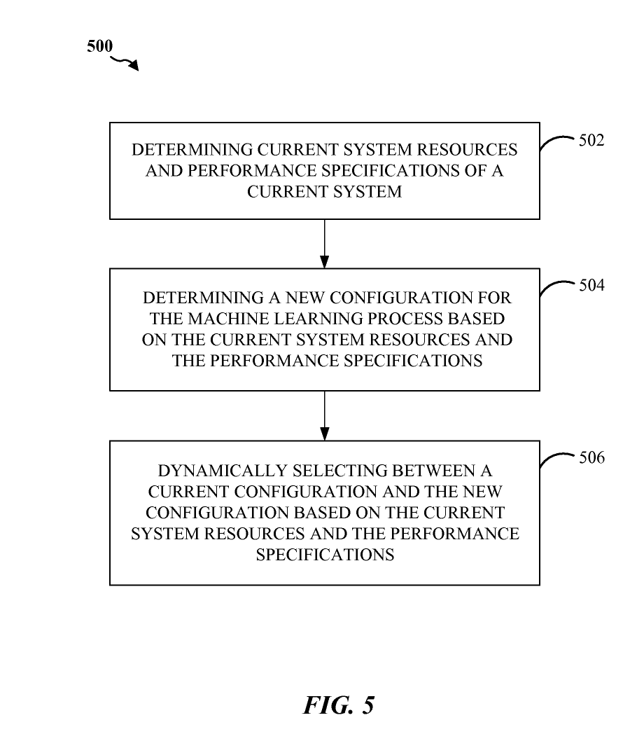

FIG. 5 illustrates a method 500 for adaptively selecting a configuration for a machine learning process. In block 502, the process determines current system resources and performance specifications of a current system. In block 504, the process determines a new configuration for the machine learning process based on the current system resources and the performance specifications. Furthermore, in block 506, the process dynamically selects between a current configuration and the new configuration based on the current system resources and the performance specifications.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of adaptively selecting a configuration for a machine learning process, comprising:
determining current system resources and performance specifications of a current system;
determining a new configuration for the machine learning process based at least in part on the current system resources and the performance specifications; and
dynamically selecting between a current configuration and the new configuration based at least in part on the current system resources and the performance specifications.

2. The method of claim 1, further comprising determining which configuration to select based at least in part on: performance of the current configuration and the new configuration, latencies associated with the current configuration and the new configuration, power consumption associated with the current configuration and the new configuration, ease of applying another configuration, processor resources associated with the current configuration and the new configuration, memory bandwidth associated with the current configuration and the new configuration, and/or communication specifications associated with the current configuration and the new configuration.

3. The method of claim 1, further comprising:
continuously executing a first configuration of the machine learning process with a first processor;
periodically executing a second configuration of the machine learning process with a second processor, the second configuration having a complexity that is greater than the complexity of the first configuration; and
aggregating results from the first configuration and the second configuration.

4. The method of claim 1, in which the machine learning process comprises an artificial neural network and the method further comprises: determining the new configuration by changing a number representation of weights and/or activations in the current configuration; adjusting hyper-parameters based at least in part on the current artificial neural network; adopting a student network derived from the current artificial neural network; decomposing filters of the current artificial neural network;
compressing the current artificial neural network; reducing image resolution of the current artificial neural network; adjusting sparsity of the current artificial neural network; changing filters of the current artificial neural network, selecting a number of samples for online learning; changing a number of candidate windows considered for localization; and/or performing saliency masking.

5. An apparatus for adaptively selecting a configuration for a machine learning process, comprising:
means for determining current system resources and performance specifications of a current system;
means for determining a new configuration for the machine learning process based at least in part on current system resources and the performance specifications; and
means for dynamically selecting between a current configuration and the new configuration based at least in part on the current system resources and the performance specifications.

6. The apparatus of claim 5, further comprising means for determining which configuration to select based at least in part on: performance of the current configuration and new configuration, latencies associated with the current configuration and new configuration, power consumption associated with the current configuration and new configuration, ease of applying another configuration, processor resources associated with the current configuration and new configuration, memory bandwidth associated with the current configuration and the new configuration, and/or communication specifications associated with the current configuration and the new configuration.

7. The apparatus of claim 5, further comprising:
means for continuously executing a first configuration of the machine learning process with a first processor;
means for periodically executing a second configuration of the machine learning process with a second processor, the second configuration having a complexity that is greater than the complexity of the first configuration; and
means for aggregating results from the first configuration and the second configuration.

8. The apparatus of claim 5, in which the machine learning process comprises an artificial neural network and the apparatus further comprises: means for determining the new configuration by changing a number representation of weights and/or activations in the current configuration; means for adjusting hyper-parameters based at least in part on the current artificial neural network; means for adopting a student network derived from the current artificial neural network; means for decomposing filters of the current artificial neural network; means for compressing the current artificial neural network;
means for reducing image resolution of the current artificial neural network; means for adjusting sparsity of the current artificial neural network; means for changing filters of the current artificial neural network; means for selecting a number of samples for online learning; means for changing a number of candidate windows considered for localization; and/or means for performing saliency masking.

9. An apparatus for of adaptively selecting a configuration for a machine learning process, comprising:
a memory; and
at least one processor coupled to the memory, the at least one processor being configured:
to determine current system resources and performance specifications of a current system;
to determine a new configuration for the machine learning process based at least in part on the current system resources and the performance specifications; and
to dynamically select between a current configuration and the new configuration based at least in part on the current system resources and the performance specifications.

10. The apparatus of claim 9, in which the at least one processor is further configured to determine which configuration to select based at least in part on performance of the current configuration and new configuration, latencies associated with the current configuration and new configuration, power consumption associated with the current configuration and new configuration, ease of applying another configuration, processor resources associated with the current configuration and new configuration, memory bandwidth associated with the current configuration and the new configuration, and/or communication specifications associated with the current configuration and the new configuration.

11. The apparatus of claim 9, in which the at least one processor is further configured:
to continuously execute a first configuration of the machine learning process with a first processor;
to periodically execute a second configuration of the machine learning process with a second processor, the second configuration having a complexity that is greater than the complexity of the first configuration; and
to aggregate results from the first configuration and the second configuration.

12. The apparatus of claim 9, in which the machine learning process comprises an artificial neural network and the at least one processor is further configured:
to determine the new configuration by changing a number representation of weights and/or activations in the current configuration; to adjust hyper-parameters based at least in part on the current artificial neural network;
to adopt a student network derived from the current artificial neural network;
to decompose filters of the current artificial neural network;
to compress the current artificial neural network;
to reduce image resolution of the current artificial neural network; to adjust sparsity of the current artificial neural network;
to change filters of the current artificial neural network; to select a number of samples for online learning;
to change a number of candidate windows considered for localization; and/or to perform saliency masking.

13. A non-transitory computer-readable medium having non-transitory program code recorded thereon, the program code comprising:
program code to determine current system resources and performance specifications of a current system;
program code to determine a new configuration for a machine learning process based at least in part on the current system resources and the performance specifications; and
program code to dynamically select between a current configuration and the new configuration based at least in part on the current system resources and the performance specifications.

14. The non-transitory computer-readable medium of claim 13, further comprising program code to determine which configuration to select based at least in part on performance of the current configuration and new configuration, latencies associated with the current configuration and new configuration, power consumption associated with the current configuration and new configuration, ease of applying another configuration, processor resources associated with the current configuration and new configuration, memory bandwidth associated with the current configuration and the new configuration, and/or communication specifications associated with the current configuration and the new configuration.

15. The non-transitory computer-readable medium of claim 13, further comprising:
program code to continuously execute a first configuration of the machine learning process with a first processor;
program code to periodically execute a second configuration of the machine learning process with a second processor, the second configuration having a complexity that is greater than the complexity of the first configuration; and
program code to aggregate results from the first configuration and the second configuration.

16. The non-transitory computer-readable medium of claim 13, in which the machine learning process comprises an artificial neural network and the non-transitory computer-readable medium further comprises: program code to determine the new configuration by changing a number representation of weights and/or activations in the current configuration; program code to adjust hyper-parameters based at least in part on the current artificial neural network; program code to adopt a student network derived from the current artificial neural network; program code to decompose filters of the current artificial neural network; program code to compress the current artificial neural network; program code to reduce image resolution of the current artificial neural network; program code to adjust sparsity of the current artificial neural network;
program code to change filters of the current artificial neural network; program code to select a number of samples for online learning; program code to change a number of candidate windows considered for localization; and/or program code to perform saliency masking.
